(19) United States
(12) Patent Application Publication
(10) Pub. No.: US 2024/0280728 A1
(43) Pub. Date: Aug. 22, 2024

(54) LOW-REFLECTION FILM AND DISPLAY DEVICE INCLUDING SAME

(71) Applicant: SAMSUNG DISPLAY CO., LTD., YONGIN-SI (KR)

(72) Inventors: JIYUN PARK, Yongin-si (KR); Tae Min KIM, Yongin-si (KR); Dong Geun SHIN, Yongin-si (KR); Gi Hoon YANG, Yongin-si (KR); Seul Gee LEE, Yongin-si (KR); Seung Hee LEE, Yongin-si (KR); Ho LIM, Yongin-si (KR)

(21) Appl. No.: 18/422,625

(22) Filed: Jan. 25, 2024

(30) Foreign Application Priority Data
Feb. 15, 2023 (KR) 10-2023-0020156

(51) Int. Cl. G02B 1/111; C08K 7/26; C08L 83/08; G02B 1/14

(52) U.S. Cl. CPC G02B 1/111; C08K 7/26; C08L 83/08; G02B 1/14; C08K 2201/003; C08K 2201/011

(57) ABSTRACT

A low-reflection film includes: a hard coating layer; and a first refraction layer, a second refraction layer, and a third refraction layer having different refractive indexes and stacked on the hard coating layer, in which the refractive index of the third refraction layer positioned furthest from the hard coating layer is a lowest, and the third refraction layer includes a compound represented by Chemical Formula 1, a compound represented by Chemical Formula 2, and a hollow material.

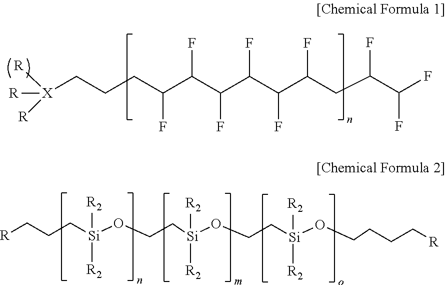

### CROSS-REFERENCE TO RELATED APPLICATION

This application claims priority under 35 U.S.C. § 119 to Korean Patent Application No. 10-2023-0020156, filed on Feb. 15, 2023, in the Korean Intellectual Property Office, the entire contents of which are incorporated by reference herein.

### TECHNICAL FIELD

The present disclosure relates to a low-reflection film and a display device including the same, and more particularly, to a display device including a low-reflection film having enhanced scratch resistance.

### DISCUSSION OF RELATED ART

When an external light is reflected or scattered on a display surface of a display device, an image of the display device may be degraded and become difficult to see. As display devices for portable devices such as mobile phones and laptops are increasingly used outdoors where there is plenty of external light, reflection and scattering of the external light on the display surface of the display device are becoming a problem that needs to be resolved.

Various methods have been proposed to resolve the problem of reflection and scattering of external light. For example, a method of attaching an antireflection film to the display surface of the display device has been used to address this problem. The antireflection film absorbs the external light reflected and scattered from the display surface of the display device, and thus, only the light generated from the display device may pass, so that the displayed image can be seen more clearly.

### SUMMARY

Embodiments of the present disclosure are to provide a low-reflection film having an enhanced scratch resistance and a display device including the same.

A low-reflection film according to an embodiment of the present disclosure includes a hard coating layer; and a first refraction layer, a second refraction layer, and a third refraction layer having different refractive indexes and stacked on the hard coating layer, in which the refractive index of the third refraction layer positioned furthest from the hard coating layer is a lowest, and the third refraction layer includes a compound represented by Chemical Formula 1, a compound represented by Chemical Formula 2, and a hollow material.

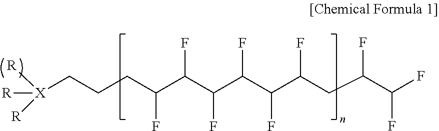

In Chemical Formula 1, R is each independently acrylate or epoxy, X is one selected from C, N, and Si, and n is 5 to 100.

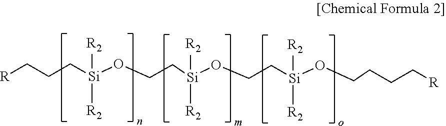

In Chemical Formula 2, each R is independently acrylate or epoxy, R₂ is one selected from chemical groups represented by Chemical Formulas 3 to 6, and n, m, and o are 1 to 100, respectively.

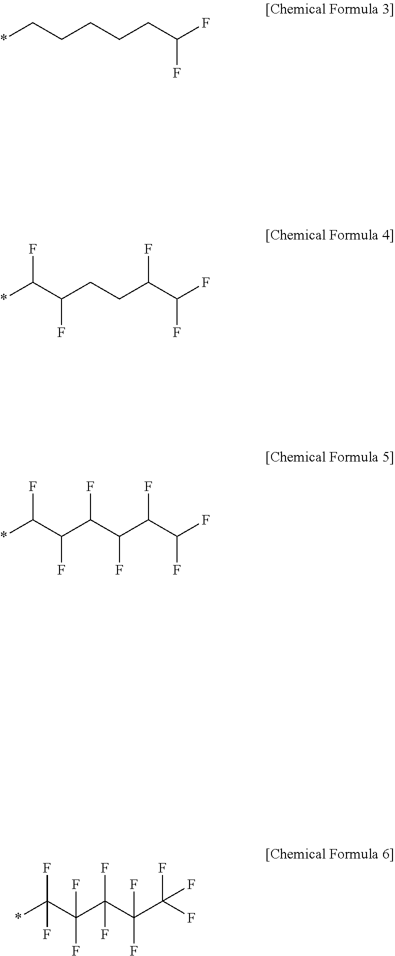 [SMILES: *CCCCCC(F)F ; *C(F)C(F)CCC(F)C(F)F ; *C(F)C(F)C(F)C(F)C(F)C(F)F ; *C(F)(F)C(F)(F)C(F)(F)C(F)(F)C(F)(F)F]

In Chemical Formulas 3 to 6, * indicates a binding site to an adjacent atom.

The third refraction layer may include a first layer and a second layer, the second layer may be positioned on the first layer, and a content of the compound of Chemical Formula 1 included in the second layer may be greater than a content of the compound of Chemical Formula 1 included in the first layer.

In the third refraction layer, a content of the compound of Chemical Formula 1 may be about 1 wt % to about 10 wt % for an entire resin of the third refraction layer.

In the third refraction layer, a content of the compound of Chemical Formula 2 may be about 5 wt % to about 20 wt % for an entire resin of the third refraction layer.

The hollow material may be a hollow silica.

A content of the hollow silica in the third refraction layer may be about 10 wt % to about 80 wt %.

A thickness of a shell of the hollow silica may be about 5 nm to about 50 nm.

A diameter of the hollow silica may be about 10 nm to about 200 nm.

The hollow material may be a hollow polymer.

A surface of the hollow polymer may include acryl, polyimide, urethane, styrene, siloxane, or epoxy.

The first refraction layer, the second refraction layer, and the third refraction layer may be sequentially positioned, the refractive index of the first refraction layer may be larger than the refractive index of the third refraction layer, and the refractive index of the second refraction layer may be larger than the refractive index of the first refraction layer.

The refractive index of the first refraction layer may be about 1.4 to about 2.0, the refractive index of the second refraction layer may be about 1.6 to about 2.2, and the refractive index of the third refraction layer may be about 1.2 to about 1.37.

A display device according to an embodiment of the present disclosure includes a display panel and a low-reflection film positioned on the display panel, in which the low-reflection film includes a hard coating layer, and a first refraction layer, a second refraction layer, and a third refraction layer having different refractive indexes and stacked on the hard coating layer, the refractive index of the third refraction layer positioned furthest from the hard coating layer is a lowest, and the third refraction layer includes a compound represented by Chemical Formula 1, a compound represented by Chemical Formula 2, and a hollow material.

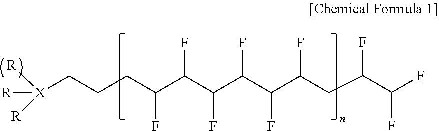

In Chemical Formula 1, each R is independently acrylate or epoxy, X is one selected from C, N, and Si, and n is 5 to 100.

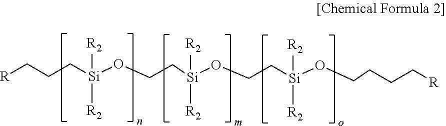

In Chemical Formula 2, each R is independently acrylate or epoxy, R₂ is one selected from chemical groups represented by Chemical Formulas 3 to 6, and n, m, and o are 1 to 100, respectively.

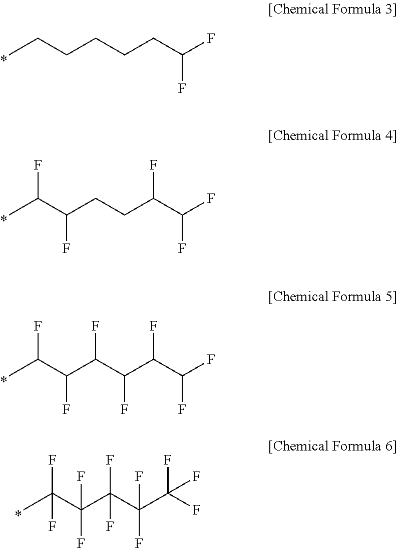

In Chemical Formulas 3 to 6, * indicates a binding site to an adjacent atom.

The third refraction layer may include a first layer and a second layer, the second layer may be positioned on the first layer, and a content of the compound of Chemical Formula 1 included in the second layer may be greater than a content of the compound of Chemical Formula 1 included in the first layer.

In the third refraction layer, a content of the compound of Chemical Formula 1 may be 1 wt % to 10 wt % for an entire resin of the third refraction layer.

In the third refraction layer, a content of the compound of Chemical Formula 2 may be 5 wt % to 20 wt % for an entire resin of the third refraction layer.

The hollow material may be a hollow silica, and a content of the hollow silica in the third refraction layer may be 10 wt % to 80 wt %.

The hollow material may be a hollow polymer, and a surface of the hollow polymer may include acryl, polyimide, urethane, styrene, siloxane, or epoxy.

The first refraction layer, the second refraction layer, and the third refraction layer may be sequentially positioned, the refractive index of the first refraction layer may be larger than the refractive index of the third refraction layer, and the refractive index of the second refraction layer may be larger than the refractive index of the first refraction layer.

The refractive index of the first refraction layer may be about 1.4 to about 2.0, the refractive index of the second refraction layer may be about 1.6 to about 2.2, and the refractive index of the third refraction layer may be about 1.2 to about 1.37.

### BRIEF DESCRIPTION OF THE DRAWINGS

The above and other aspects and features of the present disclosure will become apparent by describing in detail embodiments thereof with reference to the accompanying drawings, in which:

FIG. 1 is a view schematically showing a cross-section of a display device according to an embodiment of the present disclosure;

FIG. 2 is a view showing in detail a configuration of a low-reflection film of FIG. 1;

FIG. 3 is a view separately showing a low-reflection layer of the low-reflection film of FIG. 2;

FIG. 4 is a view schematically showing a cross-section of a low-reflection layer according to an embodiment of the present disclosure;

FIG. 5 is a view showing a low-reflection layer according to an embodiment of the present disclosure;

FIG. 6 is a view showing more in detail a stacked structure of a display device according to an embodiment of the present disclosure;

FIG. 7 is a view schematically showing a cross-section of a display device according to an embodiment of the present disclosure; and

FIG. 8 is a view showing more in detail a stacked structure of a display device according to an embodiment of the present disclosure.

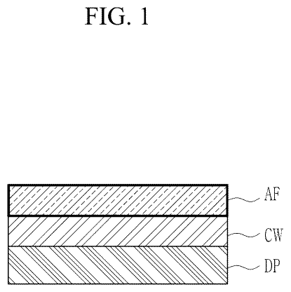

Since the drawings in FIGS. 1-8 are intended for illustrative purposes, the elements in the drawings are not necessarily drawn to scale. For example, some of the elements may be enlarged or exaggerated for clarity purpose.

### DETAILED DESCRIPTION OF THE EMBODIMENTS

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure.

To clarify the present disclosure, parts that are not connected with the description will be omitted, and the same elements or equivalents are referred to by the same reference numerals throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction. Also, terms such as “beneath”, “below”, “on”, “above” are used to describe the relationship of the components illustrated in the drawings. The above terms are relative concepts, and are described with reference to directions indicated in the drawings. These relative terms are intended to encompass different orientations of the device in use or operation, in addition to the orientation depicted in the drawings.

In addition, unless explicitly described to the contrary, the word “comprise”, and variations such as “comprises” or “comprising”, will be understood to imply the inclusion of stated elements but not the exclusion of any other elements.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Further, in the specification, the phrase “on a plane” means when an object portion is viewed from above, and the phrase “on a cross-section” means when a cross-section taken by vertically cutting an object portion is viewed from the side.

Hereinafter, a low-reflection film and a display device including the same according to the present disclosure are described with reference to accompanying drawings.

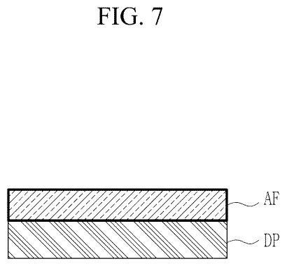

FIG. 1 is a view schematically showing a cross-section of a display device according to an embodiment of the present disclosure. Referring to FIG. 1, a display device according to an embodiment of the present disclosure may include a display panel DP, a cover window CW positioned on the display panel DP, and a low-reflection film AF positioned on the cover window CW. For example, on a cross-section, the cover window CW may be interposed between the low-reflection film AF and the display panel DP. However, the present disclosure is not limited thereto. According to an embodiment of the present disclosure, the cover window CW may be omitted. For example, the low-reflection film AF may be directly positioned on the display panel DP without the cover window CW interposed therebetween (see FIG. 7).

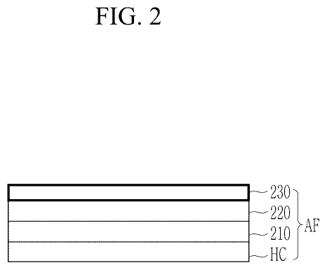

FIG. 2 is a view showing in detail a configuration of a low-reflection film of FIG. 1. Referring to FIG. 2, a low-reflection film AF according to an embodiment of the present disclosure may have a structure in which a hard coating layer HC, a middle-reflection layer 210, a high-reflection layer 220, and a low-reflection layer 230 are sequentially stacked. This is a layered structure to implement the low-reflection. A refractive index of the low-reflection layer 230 may be about 1.2 to about 1.37. A refractive index of the middle-reflection layer 210 may be about 1.4 to about 2.0. A refractive index of the high-reflection layer 220 may be about 1.6 to about 2.2. Thus, the refractive index of the middle-reflection layer 210 is larger than the refractive index of the low-reflection layer 230, and the refractive index of the high-reflection layer 220 is larger than the refractive index of the middle-reflection layer 210. In the low-reflection film AF according to an embodiment of the present disclosure, the hard coating layer HC may be positioned closest to the display panel DP, and the low-reflection layer 230 may be positioned farthest from the display panel DP. For example, the low-reflection layer 230 may be positioned on the outermost of the display device.

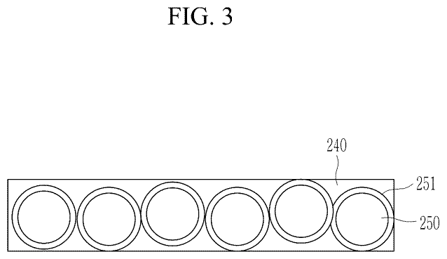

FIG. 3 is a view separately showing a low-reflection layer of the low-reflection film of FIG. 2.

Referring to FIG. 3, the low-reflection layer 230 may include a resin 240 and a hollow silica 250. The hollow silica 250 includes a shell 251 surrounding the hollow. The resin 240 may be an organic resin. As shown in FIG. 3, within the low-reflection layer 230, the hollow silica 250 may be uniformly positioned as a single layer, and this structure is suitable for a low-reflection implementation.

When the low-reflection layer 230 includes a hollow silica 250 within an organic layer, the hollow silica 250 may deteriorate the hardness of the organic film while functioning as an impurity within the film. Therefore, it is difficult for the low-reflection layer 230 having the structure like FIG. 3 to have high hardness. In other words, the low-reflection layer 230 of FIG. 3 may have low reflection, but may not have high hardness.

In the display device according to an embodiment of the present disclosure, the hardness of the low-reflection layer 230 of the low-reflection film AF is increased by including a compound represented by Chemical Formula 1 and a compound represented by Chemical Formula 2 below in the low-reflection layer 230 of the low-reflection film AF. For example, the low-reflection layer 230 of the low-reflection film AF may include a compound represented by Chemical Formula 1, a compound represented by Chemical Formula 2, and a hollow material. The hollow material may be the hollow silica 250 or a hollow polymer. That is, by including the compound represented by Chemical Formula 1 and the compound represented by Chemical Formula 2 below, the surface of the low-reflection layer 230 has a hydrophobic property, and the scratch resistance of the low-reflection film is enhanced. The structures of the compound of Chemical Formula 1 and the compound of Chemical Formula 2 are as follows.

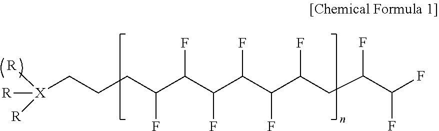

In Chemical Formula 1, each R may independently be an acrylate or an epoxy. In Chemical Formula 1, X may be one selected from C, N, and Si, and n may be 5 to 100. In Chemical Formula 1, when X is N, X links to two R's, and when X is C or Si, X links to three R's. The parenthesis “( )” means the R group enclosed is optional. In other words, the R group enclosed by the parenthesis may exist or may be omitted.

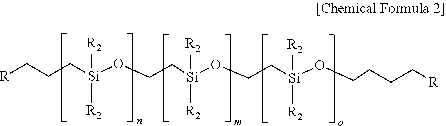

In Chemical Formula 2, each R may independently be an acrylate or an epoxy. In Chemical Formula 2, R₂ may be one selected from chemical groups represented by Chemical Formulas 3 to 6 below. For example, in an embodiment of the present disclosure, R₂ may be a fluorine-containing group having 10 or less carbon atoms. n, m, and o may be 5 to 100. In Chemical Formula 2,

R may include one or two photocuring or thermal curing groups, and when one R includes one photocuring group or thermal curing group, the other R may be OH.

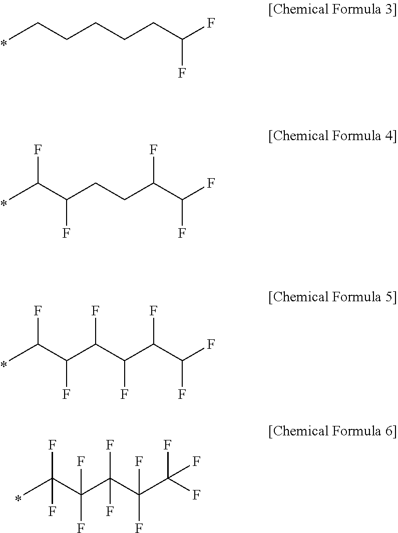

In Chemical Formulas 3 to 6, * indicates a binding site to an adjacent atom.

The compound represented by Chemical Formula 1 may increase liquid repellency while positioning on the surface of the low-reflection layer 230, and the compound represented by Chemical Formula 2 may function to help the compound represented by Chemical Formula 1 rise to the surface of the low-reflection layer 230. For example, the low-reflection layer 230 according to an embodiment of the present disclosure may have a double layer structure in which the compound represented by Chemical Formula 1 is positioned at a high concentration on the surface. For example, within the double layer, the layer at the surface has a concentration of the Chemical Formula 1 higher than that of the layer away from the surface.

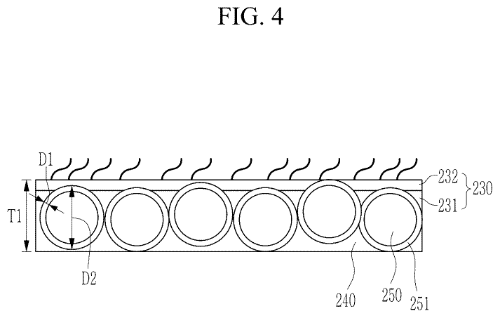

FIG. 4 is a view schematically showing a cross-section of a low-reflection layer 230 according to an embodiment of the present disclosure. Referring to FIG. 4, the low-reflection layer 230 according to an embodiment of the present disclosure includes a first layer 231 and a second layer 232. The compound of Chemical Formula 1 is mainly positioned on the second layer 232. For example, the concentration (or content) of the compound of Chemical Formula 1 included in the second layer 232 is higher than the concentration (or content) of the compound of Chemical Formula 1 included in the first layer 231. However, in the first layer 231, the compound of Chemical Formula 1 may exist. In FIG. 4, among the compounds of Chemical Formula 1, hydrophobic fluorinated groups are shown on the surface. For example, while the compound of Chemical Formula 1 is positioned on the surface of the low-reflection layer 230, the surface of the low-reflection layer 230 has hydrophobicity. Therefore, it is possible to increase the scratch resistance by increasing the slipperiness of the surface of the low-reflection layer 230. In other words, the low-reflection layer 230 of the low-reflection film AF of the display device according to the present embodiment may have hardness increased by simultaneously including the compound of Chemical Formula 1 and the compound of Chemical Formula 2.

The thickness T1 of the low-reflection layer 230 according to an embodiment of the present disclosure may be about 60 nm to about 100 nm. The thickness D1 of the shell 251 of the hollow silica 250 may be about 5 nm to about 50 nm, and the diameter D2 of the hollow silica 250 may be about 10 nm to about 200 nm. In this case, the content of the hollow silica 250 in the low-reflection layer 230 may be about 10 wt % to about 80 wt %.

In addition, the content of the compound of Chemical Formula 1 included in the low-reflection layer 230 may be about 1 wt % to about 10 wt % with respect to the entire resin. If the content of the compound in Chemical Formula 1 is less than about 1 wt %, it may not have sufficient hydrophobic properties, and if it is more than about 10 wt %, the film characteristics of the low-reflection layer 230 may be impaired. In addition, the content of the compound of Chemical Formula 2 included in the low-reflection layer 230 may be about 5 wt % to about 20 wt % with respect to the entire resin. If the compound content of Chemical Formula 2 is less than about 5 wt %, a double layer structure may not be formed, and if it is more than about 20 wt %, the film characteristics of the low-reflection layer 230 may be impaired.

As described above, the low-reflection layer 230 of the low-reflection film AF of the display device according to an embodiment of the present disclosure may have excellent scratch resistance by simultaneously including the compound of Chemical Formula 1 and the compound of Chemical Formula 2. Hereinafter, effects of the present embodiment are described.

Table 1 measures and shows an average contact angle depending on a content of the compound of Chemical Formula 1 and the compound of Chemical Formula 2.

Embodiment 1 of Table 1 represents a contact angle depending on the content of the compound of Chemical Formula 1 for the resin including the compound of Chemical Formula 2 and the compound of Chemical Formula 1. In the compound of Chemical Formula 1, a case where R is acrylate (indicated by A) and a case where R is epoxy (indicated by E) were tested, respectively. The measurements are repeated five times and the average value is derived.

TABLE 1
Including compound of Chemical Formula 2

| | Content of compound of Chemical Formula 1 | | | | | | |
|---|---|---|---|---|---|---|---|
| | No | A 1% | A 3% | A 5% | E 1% | E 3% | E 5% |
| N | 5 | 5 | 5 | 5 | 5 | 5 | 5 |
| Average contact | 53.1 | 63.2 | 76.2 | 90.4 | 64.9 | 75.3 | 80.8 |
| angle (°) | | | | | | | |
| Min | 52.6 | 62.4 | 75.9 | 89.8 | 64 | 74.6 | 80.1 |
| Max | 53.6 | 64.1 | 76.6 | 91 | 65.9 | 76.1 | 81.3 |
| STD | 0.4 | 0.6 | 0.3 | 0.5 | 0.8 | 0.7 | 0.5 |

Referring to Table 1, the average contact angle of the case without including the compound of Chemical Formula 1 is represented as 53.1 degrees, however the average contact angle of the case including the compound of Chemical Formula 1 is represented as 63.2 to 90.4 degrees, so it may be confirmed that the contact angle is increased. With the compound of Chemical Formula 1 having content from 1 wt % to 5 wt % in Embodiment 1, in the case where R is acrylate (indicated by A), the average contact angle is from 63.2 to 90.4 degrees, and in the case where R is epoxy (indicated by E), the average contact angle is from 64.9 to 80.8 degrees. This means that the surface of the low-reflection layer 230 became hydrophobic by the compound of Chemical Formula 1. Table 2 shows the contact angle according to the compound content of Chemical Formula 1 for the case where the compound of Chemical Formula 1 is included but the compound of Chemical Formula 2 is not included. In the compound of Chemical Formula 1, the case where R is acrylate and the case where R is epoxy were tested, respectively. The measurement is repeated five times and the average value is derived.

TABLE 2
No compound of Chemical Formula 2

| | Content of compound of Chemical Formula 1 | | | | | | |
|---|---|---|---|---|---|---|---|
| | No | A 1% | A 3% | A 5% | E 1% | E 3% | E 5% |
| n | 5 | 5 | 5 | 5 | 5 | 5 | 5 |
| Average contact | 52.4 | 48.9 | 48.0 | 49.9 | 58.7 | 67.7 | 69.9 |
| angle (°) | | | | | | | |
| Min | 51.9 | 48.1 | 46.1 | 49.3 | 57.9 | 67.1 | 68.8 |
| Max | 53.2 | 49.5 | 49.8 | 50.3 | 59.6 | 68.2 | 71 |
| STD | 0.5 | 0.6 | 1.4 | 0.4 | 0.7 | 0.4 | 0.9 |

In Table 2, the average contact angle of the case without including the compound of Chemical Formula 1 and without including the compound of Chemical Formula 2 is represented as 52.4 degrees. However, in the case including the compound of Chemical Formula 1 without including the compound of Chemical Formula 2, the average contact angle is represented as 48.9 to 69.9 degrees, and it was confirmed that the contact angle is decreased compared with Table 1 all including the compound of Chemical Formula 1 and the compound of Chemical Formula 2. With the compound of Chemical Formula 1 having content from 1 wt % to 5 wt % and the compound of Chemical Formula 2 having no content, in the case where R is acrylate (indicated by A), the average contact angle is from 48.9 to 49.9 degrees, and in the case where R is epoxy (indicated by E), the average contact angle is from 58.7 to 69.9 degrees. That is, as in the present embodiment, it was confirmed that the contact angle decreases in the case in which both the compound of Chemical Formula 1 and the compound of Chemical Formula 2 were included compared to the case in which only the compound of Chemical Formula 1 was included. This is because, as described above, the compound of Chemical Formula 2 serves to float the compound of Chemical Formula 1 to the surface of the low-reflection layer 230.

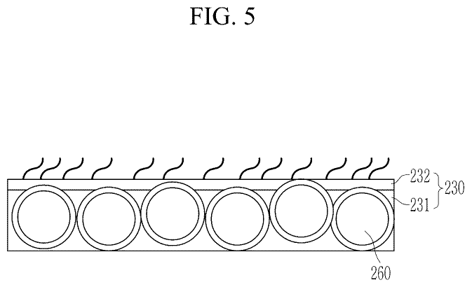

In the previous embodiment, the configuration in which the low-reflection layer 230 includes the hollow silica 250 is disclosed, but according to an embodiment of the present disclosure, the low-reflection layer 230 may include a hollow polymer. FIG. 5 is a view showing a low-reflection layer 230 according to an embodiment of the present disclosure. FIG. 5 is the same as that of FIG. 4 except for the hollow polymer 260 instead of the hollow silica 250. The detailed description for the same constituent elements is omitted. The surface of hollow polymer 260 may include acryl, polyimide, urethane, styrene, siloxane, or epoxy.

In addition, the low-reflection layer 230 according to an embodiment of the present disclosure may further include additives such as a UV hardener, an initiator, and/or an absorber.

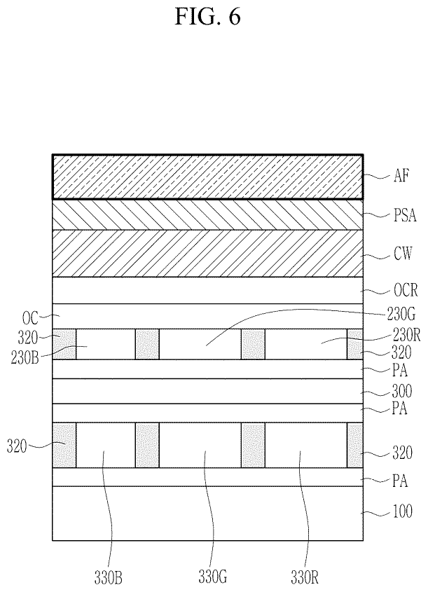

FIG. 6 is a view showing more in detail a stacked structure of a display device according to an embodiment of the present disclosure. Referring to FIG. 6, the display device may include a substrate 100 including a light-emitting element, and a red color conversion layer 330R, a green color conversion layer 330G, and a transmission layer 330B positioned on the substrate 100. In an embodiment of the present disclosure, the light-emitting element may be an organic light emitting diode (OLED). An insulating layer PA may be positioned between the substrate 100, and the red color conversion layer 330R, the green color conversion layer 330G, and the transmission layer 330B. A light blocking member 320 may be positioned between the red color conversion layer 330R, the green color conversion layer 330G, and the transmission layer 330B, respectively. The red color conversion layer 330R, the green color conversion layer 330G, and the transmission layer 330B may include quantum dots. In an embodiment of the present disclosure, the light-emitting element of the substrate 100 may generate a blue light. The quantum dots of the red color conversion layer 330R may convert the blue light to a red light, the quantum dots of the green color conversion layer 330G may convert the blue light to a green light, and the quantum dots of the transmission layer 330B may transmit the blue light. In an embodiment of the present disclosure, the light-emitting element of the substrate 100 may include an organic material including a fluorescent or phosphorescent material that emits red, green, blue, or white light. A red color filter 230R, a green color filter 230G, and a blue color filter 230B may be positioned overlapping the red color conversion layer 330R, the green color conversion layer 330G, and the transmission layer 330B, respectively. The green color filter 230G may block light which is not within the green wavelength region, the red color filter 230R may block light which is not within the red wavelength region and the blue color filter 230B may block light which is not within the blue wavelength region. The light blocking member 320 may also be positioned between the red color filter 230R, the green color filter 230G, and the blue color filter 230B.

A refraction layer 300 may be positioned between the red color conversion layer 330R, the green color conversion layer 330G, and the transmission layer 330B, and the red color filter 230R, the green color filter 230G, and the blue color filter 230B. The insulating layer PA may be positioned under and on the refraction layer 300.

An overcoat layer OC may be positioned on the red color conversion layer 330R, the green color conversion layer 330G, and the transmission layer 330B. An adhesive layer OCR may be positioned on the overcoat layer OC. The adhesive layer OCR may include an optically clear resin.

A cover window CW may be positioned on the adhesive layer OCR. The cover window CW may be made of a transparent insulating material, and may include, for example, glass, sapphire, or plastic. A low-reflection film AF may be positioned on the cover window CW. A pressure-sensitive adhesive layer PSA may be positioned between the cover window CW and the low-reflection film AF to attach the low-reflection film AF to the cover window CW. The pressure-sensitive adhesive layer PSA may be an optically clear adhesive layer. The content for the low-reflection film AF is the same as that above-described so that the detailed description for the same constituent elements is omitted.

In the above, the embodiment including the cover window CW has been described, however the cover window CW may be omitted according to an embodiment of the present disclosure.

FIG. 7 is a view showing a cross-section the same as or similar to that of FIG. 1 according to an embodiment of the present disclosure. FIG. 7 is the same as FIG. 1 except for the point of not including the cover window CW from FIG. 1. The detailed description for the same constituent elements is omitted. For example, in the display device according to the present embodiment, the low-reflection film AF may be coated and formed directly on the display panel DP.

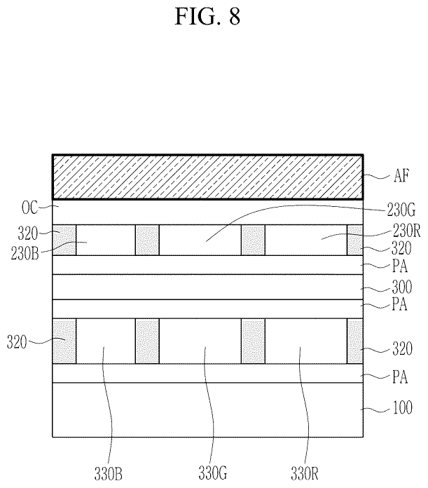

FIG. 8 is a view showing a cross-section the same as or similar to that of FIG. 6 according to an embodiment of the present disclosure. FIG. 8 is the same as FIG. 6 except for the point without including the cover window CW from FIG. 6. The detailed description for the same constituent elements is omitted. Referring to FIG. 8, the low-reflection film AF may be positioned on the overcoat layer OC. For example, the display device according to the present embodiment does not include the pressure-sensitive adhesive layer PSA, the cover window CW and the adhesive layer OCR, and the low-reflection film AF may be directly coated and formed on the display panel DP.

While the present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the present disclosure as defined by the appended claims.

What is claimed is:

1. A low-reflection film comprising:
a hard coating layer; and
a first refraction layer, a second refraction layer, and a third refraction layer having different refractive indexes and stacked on the hard coating layer,
wherein the refractive index of the third refraction layer positioned furthest from the hard coating layer is a lowest, and
the third refraction layer includes a compound represented by Chemical Formula 1, a compound represented by Chemical Formula 2, and a hollow material: 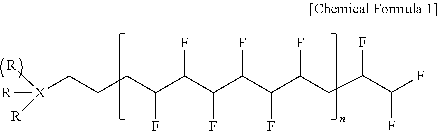
in Chemical Formula 1, each R is independently acrylate or epoxy, X is one selected from C, N, and Si, and n is 5 to 100; 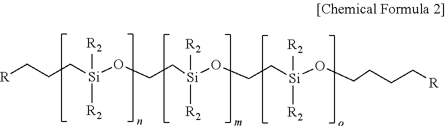
in Chemical Formula 2, each R is independently acrylate or epoxy, R₂ is one selected from chemical groups represented by Chemical Formulas 3 to 6, and n, m, and o are 1 to 100, respectively; 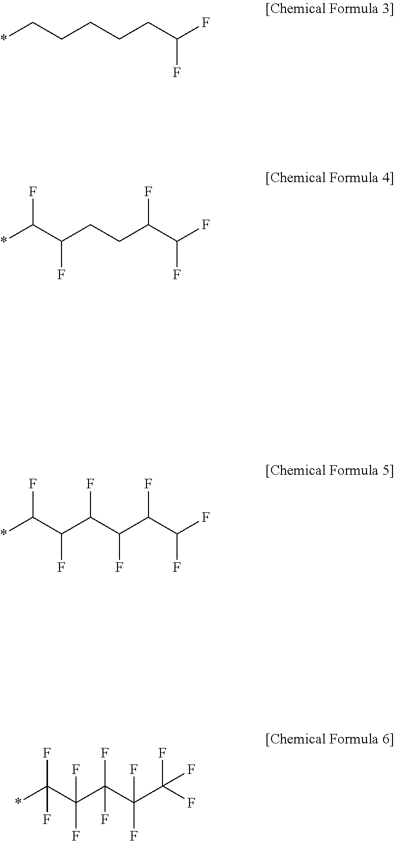 [SMILES: *CCCCCC(F)F ; *C(F)C(F)CCC(F)C(F)F ; *C(F)C(F)C(F)C(F)C(F)C(F)F ; *C(F)(F)C(F)(F)C(F)(F)C(F)(F)C(F)(F)F]
in Chemical Formulas 3 to 6, * indicates a binding site to an adjacent atom.

2. The low-reflection film of claim 1, wherein
the third refraction layer includes a first layer and a second layer,
the second layer is positioned on the first layer, and
a content of the compound of Chemical Formula 1 included in the second layer is greater than a content of the compound of Chemical Formula 1 included in the first layer.

3. The low-reflection film of claim 1, wherein
in the third refraction layer, a content of the compound of Chemical Formula 1 is about 1 wt % to about 10 wt % for an entire resin of the third refraction layer.

4. The low-reflection film of claim 1, wherein
in the third refraction layer, a content of the compound of Chemical Formula 2 is about 5 wt % to about 20 wt % for an entire resin of the third refraction layer.

5. The low-reflection film of claim 1, wherein
the hollow material is a hollow silica.

6. The low-reflection film of claim 5, wherein
a content of the hollow silica in the third refraction layer is about 10 wt % to about 80 wt %.

7. The low-reflection film of claim 5, wherein
a thickness of a shell of the hollow silica is about 5 nm to about 50 nm.

8. The low-reflection film of claim 5, wherein
a diameter of the hollow silica is about 10 nm to about 200 nm.

9. The low-reflection film of claim 1, wherein
the hollow material is a hollow polymer.

10. The low-reflection film of claim 9, wherein
a surface of the hollow polymer includes acryl, polyimide, urethane, styrene, siloxane, or epoxy.

11. The low-reflection film of claim 1, wherein
the first refraction layer, the second refraction layer, and the third refraction layer are sequentially positioned,
the refractive index of the first refraction layer is larger than the refractive index of the third refraction layer, and
the refractive index of the second refraction layer is larger than the refractive index of the first refraction layer.

12. The low-reflection film of claim 11, wherein
the refractive index of the first refraction layer is about 1.4 to about 2.0,
the refractive index of the second refraction layer is about 1.6 to about 2.2, and
the refractive index of the third refraction layer is about 1.2 to about 1.37.

13. A display device comprising:
a display panel; and
a low-reflection film positioned on the display panel,
wherein the low-reflection film includes:
a hard coating layer; and
a first refraction layer, a second refraction layer, and a third refraction layer having different refractive indexes and stacked on the hard coating layer,
the refractive index of the third refraction layer positioned furthest from the hard coating layer is a lowest, and
the third refraction layer includes a compound represented by Chemical Formula 1, a compound represented by Chemical Formula 2, and a hollow material: 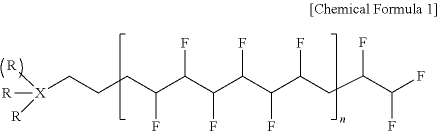
in Chemical Formula 1, each R is independently acrylate or epoxy, X is one selected from C, N, and Si, and n is 5 to 100; 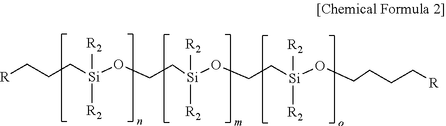
in Chemical Formula 2, each R is independently acrylate or epoxy, R₂ is one selected from chemical groups represented by Chemical Formulas 3 to 6, and n, m, and o are 1 to 100, respectively; 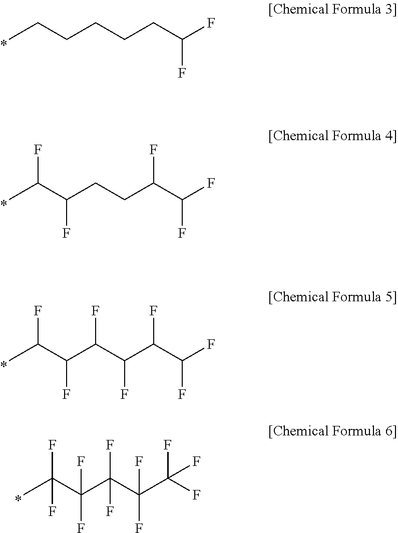
in Chemical Formulas 3 to 6, * indicates a binding site to an adjacent atom.

14. The display device of claim 13, wherein
the third refraction layer includes a first layer and a second layer,
the second layer is positioned on the first layer, and
a content of the compound of Chemical Formula 1 included in the second layer is greater than a content of the compound of Chemical Formula 1 included in the first layer.

15. The display device of claim 13, wherein
in the third refraction layer, a content of the compound of Chemical Formula 1 is about 1 wt % to about 10 wt % for an entire resin of the third refraction layer.

16. The display device of claim 13, wherein
in the third refraction layer, a content of the compound of Chemical Formula 2 is about 5 wt % to about 20 wt % for an entire resin of the third refraction layer.

17. The display device of claim 13, wherein
the hollow material is a hollow silica, and
a content of the hollow silica in the third refraction layer is about 10 wt % to about 80 wt %.

18. The display device of claim 13, wherein
the hollow material is a hollow polymer, and
a surface of the hollow polymer includes acryl, polyimide, urethane, styrene, siloxane, or epoxy.

19. The display device of claim 13, wherein
the first refraction layer, the second refraction layer, and the third refraction layer are sequentially positioned,
the refractive index of the first refraction layer is larger than the refractive index of the third refraction layer, and
the refractive index of the second refraction layer is larger than the refractive index of the first refraction layer.

20. The display device of claim 13, wherein
the refractive index of the first refraction layer is about 1.4 to about 2.0,
the refractive index of the second refraction layer is about 1.6 to about 2.2, and
the refractive index of the third refraction layer is about 1.2 to about 1.37.
